(19) United States
(12) Patent Application Publication
(10) Pub. No.: US 2006/0114366 A1
(43) Pub. Date: Jun. 1, 2006

(54) Flat-panel display apparatus

(75) Inventor: Shen-Hong Chou, Toufen Township (TW)

Correspondence Address: ARENT FOX PLLC, 1050 CONNECTICUT AVENUE, N.W., SUITE 400, WASHINGTON, DC, 20036, US

(73) Assignee: AU OPTRONICS CORPORATION

(21) Appl. No.: 11/000,459

(22) Filed: Dec. 1, 2004

(51) Int. Cl. G02F 1/1333

(52) U.S. Cl. 349/58

(57) ABSTRACT

A flat-panel display apparatus is provided to increase the color smoothness and brightness of the resultant image by enhancing the light emitted from a light guiding unit. The apparatus provides improved flat-panel display color uniformity from the light emanating from the light guiding unit. The apparatus comprises a gap disposed between the light guiding unit and a panel and its associated optical layers. The gap is located in a close proximity to the light guiding unit. Moreover, the flat-panel display apparatus further comprises a light transmissive plate disposed inside the gap.

### BACKGROUND OF THE INVENTION

1. Field of the Invention

The present invention relates to flat-panel display technology and associated luminescence apparatus, along with control of color and light emission characteristics of the images displayed.

2. Description of the Related Art

In recent years, flat-panel displays (FPDs) have been receiving attention as slim, large-sized color screen displays, and are becoming increasingly common in business and consumer applications. Flat-panel displays are generally provided in electronic products, such as notebook computers, desktop monitors, televisions, digital cameras, DVD players, PDAs, mobile phones, portable games, and car navigation systems, among other applications. Therefore, the ubiquitous application of flat-panel technology has led to ever-increasing needs for enhanced color sensing methods and the control of light emitted from the associated light sources.

In FIG. 1 (related art), a cross-section of a conventional flat-panel display 101 is illustrated. There are light sources 102 disposed typically at the periphery of a light guiding unit 103, along with light source reflectors 104. A diffuser 105 is disposed between a light guiding surface 106a of the light guiding unit 103 and a liquid crystal display (hereinafter “LCD”) panel 107. The light sources 102, in cooperation with the light source reflectors 104, provide a mechanism for efficiently directing the emitted light into and through an incident light surface 106b. In the proximity of the backside, or bottom, as illustrated, of the light guiding unit's reflecting surface 106c is a reflector sheet 108. The light sources 102 are that of conventional LED(s) (light-emitting diode(s)), including, but not limited to, linear light tubes, which emit light into the liquid crystal display pane 107 by means of the light guiding unit 103.

Such conventional flat-panel displays often include a light guiding unit abutting a plurality of various photo-active layers, such as diffuser, mentioned above, reflective polarizer layers, e.g., brightness enhancement layers “BEF”, etc. Further, the light guiding unit and photo-active layers are disposed between the flat-panel display panel and a reflector, e.g., reflective sheet.

Conventional display assemblies can contain active-matrix LCD color screens, having TFT-LCD panels, driver ICs, control circuitry, and power supply circuitry, for example.

However, the related art construction suffers from a number of well-known drawbacks, mainly for brightness and color uniformity. Accordingly, there is intent to address these deficiencies, such as increasing the number of light sources, thus increasing car consumption and device manufacturing costs. For related art designs, much of the battery power is utilized to offset the high absorption of the multi-element photoactive layers of the LCD. In particular, LCDs are particularly inefficient, wherein efficiency losses are due to the use of polarizers, color filters, and other elements such that the final light transmission is in the low percentage points.

Thus, a major disadvantage of related art light lies in the emitted light from the light guide source lacking consistency and smoothness in the resultant displayed color.

Therefore, there is a present need for improved color smoothness and brightness apparatuses and methods for flat-panel display units. Therefore, it is widely recognized that LCDs with higher output luminous efficiency, in uniformity of color, i.e., smoothness, will be required for future display technologies. Accordingly, the present invention provides an apparatus with improving color smoothness and brightness.

### SUMMARY OF THE INVENTION

The present invention has been made to solve the problems associated with the related art having low and/or inconsistent color smoothness and brightness in flat-panel displays (FPDs) as described above.

It is an object of the present invention to provide a flat-panel display achieving increased color smoothness across the emitted display image, along with an increased brightness of the display. More specifically, it is an object of the present invention, to provide a flat-panel display apparatus, which utilize a layer structure that provides enhanced visual characteristics of the displayed imaged. Thus, a principal object of the present invention is to improve the color uniformity of the transmitted light from the LED light guide source.

It is an object of the present invention to provide a flat-panel display apparatus, which provides increased color smoothness and brightness compared to the prior art. The flat-panel display apparatus comprises a light guiding unit, a panel disposed over the light guiding unit, and a frame holding the light guiding unit and the panel. The apparatus is configured such that a gap is formed between the light guide unit and the panel, and light emitting from the light guide unit passes through the gap. The flat-panel display apparatus further comprises a light transmissive plate disposed inside the gap.

It is another object of the present invention to provide a flat-panel display system for increasing the color smoothness and brightness of light emitted from a light guide means and passing through a gap means. The gap means is disposed between the light guide means and the flat-panel display screen. Furthermore, the gap means comprises a void means and/or a light transmissive means.

To attain the purposes described above, the present invention provides a gap for light emitting from the light guide unit to optimize color smoothness and brightness for flat-panel displays.

A major disadvantage of the related art flat-panel display techniques lies in their inability to deliver consistent smoothness of color over the complete display image screen without having dark spots or “faded” color areas irrespective of the specific image content.

These and other objects and advantages of this invention will become apparent when considered in light of the following description and claims when taken together with the accompanying drawings.

### BRIEF DESCRIPTION OF THE DRAWINGS

The accompanying drawings are included to provide further understanding of the present invention and are incorporated in, and constitute a part of, the specification, illustrating samples of the present invention, and together with the description, serve to explain the principles of the present invention.

The invention will now be described further with reference to the accompanying drawings in which:

FIG. 1 illustrates a conventional flat-panel display assembly according to the related art;

FIGS. 2A-2C illustrate cross-sectional views of photoactive layers of flat-panel displays according to various preferred embodiments of the present invention;

FIG. 3 illustrates a cross-sectional view of the color smoothness and brightness enhancing FPD assembly according to the preferred embodiment of the present invention;

FIG. 4 illustrates a cross-sectional view of the color smoothness and brightness enhancing FPD assembly according an alternative embodiment of the present invention;

FIG. 5 illustrates a cross-sectional view of a color smoothness and brightness enhancing FPD assembly according to an alternative embodiment of the present invention.

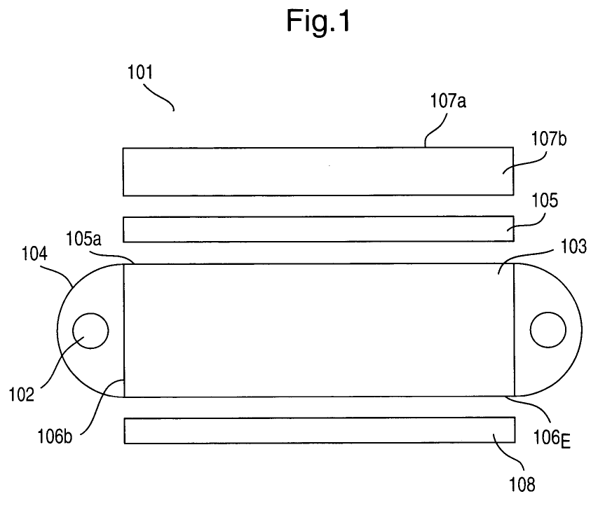

### DETAILED DESCRIPTION OF THE PREFERRED EMBODIMENTS

The following section describes an embodiment of the present invention based on drawings, while exemplifying the color smoothness and brightness enhancing assembly, apparatus of the present invention.

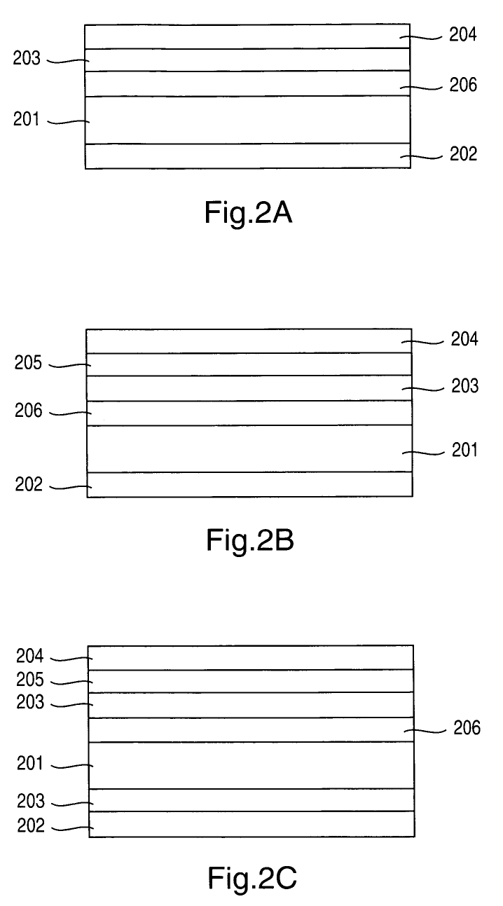

In FIG. 2A, a light guiding unit 201 is disposed between a reflector 202 and a diffuser 203 coupled to a panel 204, e.g. a LCD panel. In FIG. 2B, a light guiding unit 201 is coupled to a reflector 202, wherein the light guiding unit 201 is disposed between the reflector 202 and a plurality of optical layers, in this case a diffuser 203 and a polarizer 205. In FIG. 2C, a diffuser 203 is disposed between a reflector 202 and a light guiding unit 201, wherein a plurality of optical layers, e.g., a polarizer 205 and a diffuser 203, are disposed between a panel 204 and the light guiding unit 201. The FPD apparatus of the present invention contains a gap 206 located at an interface location between the light guiding unit 201 and the diffuser 203 that is coupled to the panel 204.

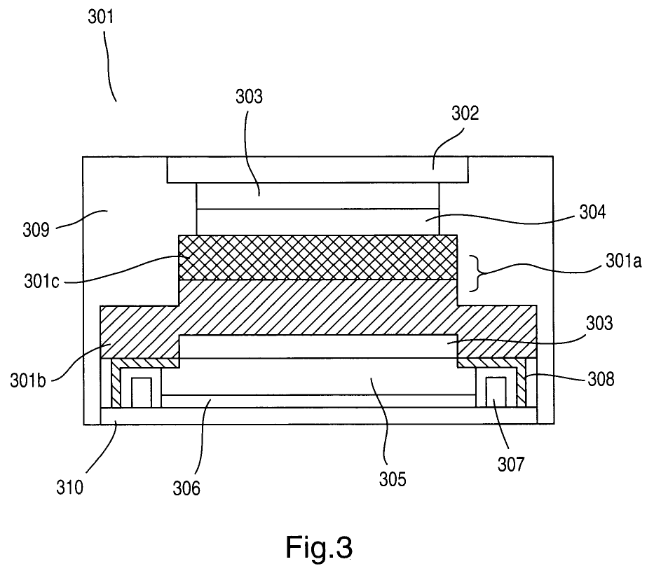

FIG. 3 illustrates a cross-sectional view of a FPD assembly having the color smoothness and increased brightness gap area 301a of the preferred embodiment of the present invention. A flat-panel display apparatus comprises a panel 302 coupled to a diffuser 303b and a reflective polarizer 304, e.g., brightness enhancing film (“BEF”), and a light guiding unit 305 disposed between a reflective sheet 306 and a diffuser 303a. A gap 301a is formed that is disposed between the diffuser 303a and the reflective polarizer 304 layer. The flat-panel display apparatus further comprises a light transmissive plate 301b disposed inside the gap 301a. LEDs 307 are included as a light source and a reflector surface 308 at least partially surrounding the same are included. A frame 309 is included to structurally house the aforementioned flat-panel display elements, along with a base unit 310.

The gap 301a of the present invention is of a height “a” substantially between 5.0 mm-50 mm. Further, wherein a height “b” of the light transmissive plate 301b is substantially at least 2.0 mm.

A light guiding unit of the present invention has one or more incident light surfaces to receive light emitted from one or more light sources.

It should be noted that the reflector surface or sheet could be any highly reflective material, such as polymeric, metallic or composite material. An example of a metallic material would be aluminum or steel. As a general matter, the material needs to be reflective of light.

In this embodiment of the present invention the gap provides increased color smoothness and brightness of the resultant image displayed on the flat-panel display apparatus, as compared to the prior art constructions.

The gap increases the amount of the emitted light exiting the light guiding unit, which in turn passes through to an FPD screen. Therefore, in contradistinction to the related art, wherein dark regions appear on the light emitting surface of the light guiding unit, the present invention provides for the enhanced emission of light leading to the FPD screen having even color and brightness.

Thus, the invention provides for increased color uniformity as compared to the related art. Color uniformity can be expressed as a number by the color deviation from the desired white point (ΔUV):

The related art value of ΔUV is about 0.015. However, the present invention's gap permits a color uniformity value of about 0.007 to be achieved.

Light that enters the light guiding unit is internally reflected out of the top and bottom. Light that strikes the top surface of the light guiding unit at an angle less than the critical angle will pass on to the diffuser, whereas light that strikes an angle greater than the critical angle will reflect back into the light guiding unit. The reflector will then redirect such light back through the light guiding unit toward the diffuser. The light that strikes the reflective polarizer, which itself allows only light that is greater than the polarization angle to pass, will pass therethrough and backlight the FPD screen to provide an image. The surface of the diffuser alters the polarization of the light and reflects a significant portion of the light back towards the reflective polarizer. The light portion of the reflective light with the correct polarization is passed through the reflective polarizer on to the FPD screen.

With reference to 2A-2C, the gap 206 of the present invention is disposed at the interface locations between the light guiding unit 201 and the diffuser 203 coupled to the panel 204 and/or the polarizer 205, wherein the light guiding unit 201 does not have a diffuser located proximate to its light emitting surface. Alternately, as in FIG. 3, the gap 301a of the present invention is disposed between the diffuser 303a coupled to the light guiding unit 305 and the reflective polarizer 304 and/or diffuser 303b coupled to be panel 302.

It should be noted that the present invention utilizes various embodiments of utilizing different diffuser unit arrangements. In one embodiment, the diffuser is an integral part of the light transmissive plate, thus imparting a diffuser functionality to the light transmissive plate. In other alternative embodiments, the diffuser can be either one distinct unit or two distinct units. The diffuser units can be disposed below and/or above the gap.

It should be noted that alternative embodiments of the present invention in addition can provide multiple light guiding units along with multiple optical layers.

It should be noted that the light transmissive plate is an optically transparent material composition. The light transmissive plate also possesses minimal absorbency of light emitted from the light guiding unit. Further, the light transmissive plate of the present invention is made of a material selected from the group consisting of acrylics, glasses, polymethyl-methacrlate (“PMMA”). The light transmissive plate is formed of a material, such as a resin material and glass, and is preferably of a resin material. Examples include acrylic resin, methacrylic resin, polycarbonate resin, polyester resin or cyclic olefin resin. Among these, acrylic resin and methacrylic resins are especially preferred given their high transparency with low optical attenuation loss. In addition, the light transmissive plate of the invention can be to have a porous structure.

The light transmissive plate is characterized in that the angle of the light transmitted and emitted out of it is greater than that of the light emitted out of the light guiding structure. Similarly, the refractive index (“n1”) of the light transmissive plate is less than that of the refractive index (“n2”) of the light guiding structure. Thus, the present invention satisfies the following formula:
n1<n2 (1)

It should be noted that the prior art range for n2 is in the range of 1.2 to 2.0, whereas the present invention's range for n1 is 1.0 to 1.95. Therefore, the light transmitted out of the light transmissive plate has a greater angle than that emitted from the light guiding structure, thus providing increased brightness and color smoothness of the flat-panel display. This also reduces the presence of low contrast, e.g., dark spots, in the flat-panel display.

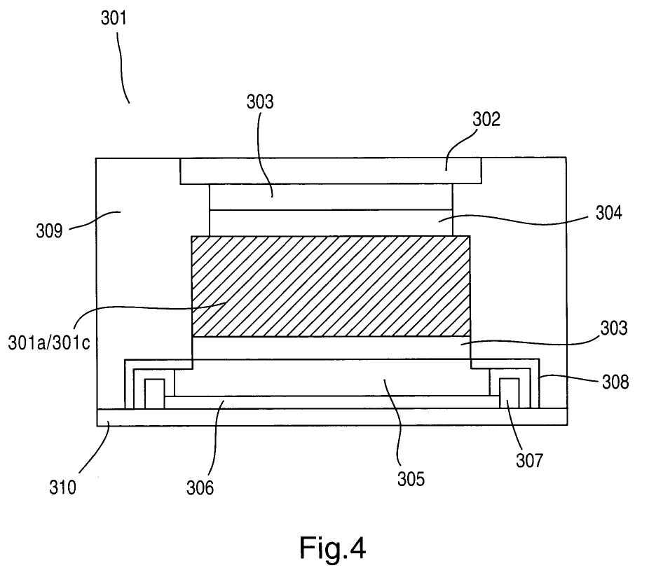

FIG. 4 illustrates another alternative flat-panel display apparatus 401 according to the present invention. In FIG. 4, a gap 401a of another embodiment of the present invention is composed solely of a light transmissive plate, which is disposed between a light guiding unit 405 coupled to a diffuser 403a and a panel 402 coupled to a diffuser 403b and a reflective polarizer layer 404. The flat-panel display apparatus 401 also comprises a reflective sheet 406, an LED 407, a reflector surface 408, a frame 409, and a base unit 410, similar to the flat-panel display apparatus 301 shown in FIG. 3.

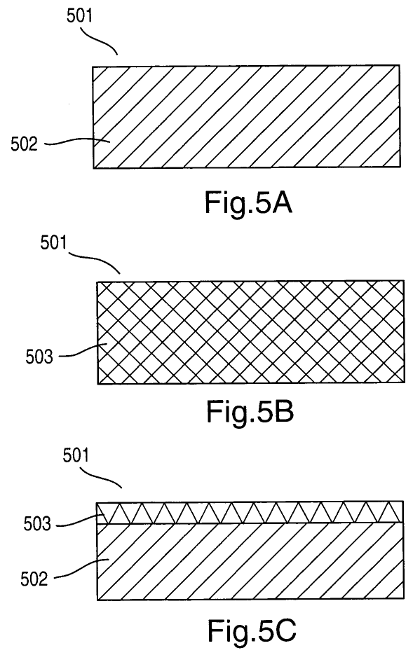

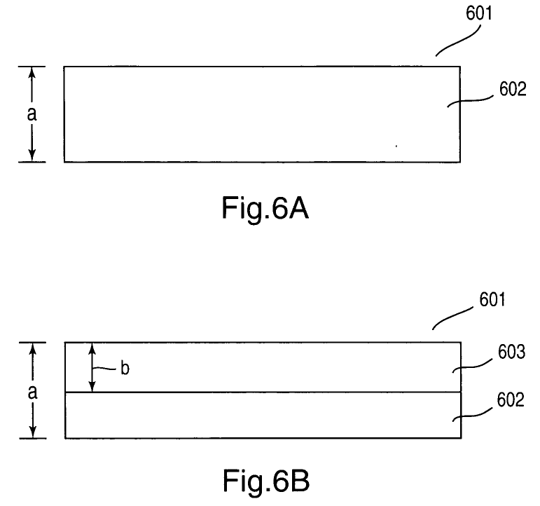

FIG. 5 illustrates an alternative embodiment of a cross-sectional view of a FPD assembly having a gap 501a. A flat-panel display apparatus 501 comprises a panel 502 coupled to a diffuser 503b and a reflective polarizer 504, e.g., brightness enhancing film (“BEF”), and a light guiding unit 505 disposed between a reflective sheet 506 and a diffuser 503a. The color smoothness and brightness increasing gap 501a is provided and is disposed between the diffuser 503a coupled to the light guiding unit 505 and the reflective polarizer 504 layer coupled to the diffuser 503b and the panel 502. LEDs 507 are included as a light source and a reflector surface 508 at least partially surrounds the same. A frame 509 is included to structurally house the aforementioned flat-panel display elements, along with a base unit 510.

Those skilled in the art will recognize that the apparatus of the present invention have many applications, and that the present invention is not limited to the representative examples disclosed herein. Although illustrative, the embodiments disclosed herein have a wide range of modification, change and substitution that is intended, and in some instances, some features of the present invention may be employed without a corresponding use of the other features.

Moreover, the scope of the present invention covers conventionally known variations and modifications to the system components described herein, as would be known by those skilled in the art. Accordingly, it is appropriate that the appended claims be construed broadly and in a manner consistent with the scope of the invention.

What is claimed is:

1. A flat-panel display apparatus comprising:
a light guiding unit;
a panel disposed over the light guiding unit; and
a frame holding the light guiding unit and the panel, wherein a gap is formed between the light guiding unit and the panel.

2. The flat-panel display apparatus according to claim 1, further comprising a LED, disposed near an edge of the light guiding unit.

3. The flat-panel apparatus according to claim 1, wherein the gap has a height in a range of 5.0 mm-50 mm.

4. The flat-panel display apparatus according to claim 1, further comprising a light transmissive plate disposed inside the gap.

5. The flat-panel display apparatus according to claim 4, wherein the transmissive plate is disposed on the panel.

6. The flat-panel display apparatus according to claim 4, wherein the light transmissive plate is made of a material selected from the group consisting of acrylics, glass and polymethyl-methacrylate.

7. The flat-panel display apparatus according to claim 4, wherein the light transmissive plate is made of a material selected from the group consisting of acrylic resin, methacrylic resin, polycarbonate resin, polyester resin and cyclic olefin resin.

8. The flat-panel display apparatus according to claim 4, wherein the light transmissive plate is a porous structure.

9. The flat-panel display apparatus according to claim 4, wherein the light transmissive plate has a height of substantially at least 2.0 mm.

10. The flat-panel display apparatus according to claim 4, wherein a refractive index (“n1”) of the light transmissive plate satisfies the following relationship relative to a refractive index (“n2”) of the light guiding unit:
n1<n2

11. The flat-panel display apparatus according to claim 1, further comprising an optical layer disposed on the panel.

12. The flat-panel display apparatus according to claim 11, the optical layer being a diffuser.

13. The flat-panel display apparatus according to claim 11, the optical layer being a reflective polarizer.

14. The flat-panel display apparatus according to claim 1, further comprising an optical layer disposed on the light guiding unit.

15. The flat-panel display apparatus according to claim 14, the optical layer being a diffuser.
